(19) United States
(12) Patent Application Publication
(10) Pub. No.: US 2026/0159387 A1
(43) Pub. Date: Jun. 11, 2026

(54) HYDRIDE ION CONDUCTOR AND PREPARATION METHOD THEREOF

(71) Applicant: GWANGJU INSTITUTE OF SCIENCE AND TECHNOLOGY, Gwangju (KR)

(72) Inventors: Sang Ryun KIM, Gwangju (KR); Tae Hyun KIM, Gwangju (KR)

(21) Appl. No.: 19/373,487

(22) Filed: Oct. 29, 2025

(30) Foreign Application Priority Data
Dec. 5, 2024 (KR) 10-2024-0179525

(51) Int. Cl. C01B 6/21

(52) U.S. Cl. CPC C01B 6/21; C01P 2002/30; C01P 2002/72; C01P 2006/40

(57) ABSTRACT

The present inventive concept relates to a hydride ion conductor represented by Formula 1, having a cubic crystal structure, and having the P4̅3m space group (No. 215). According to the present inventive concept, without relying on conventional highly oxidative elements, such as oxygen (O), fluorine (F), or iodine (I), a hydride ion conductor having a stable crystal structure and capable of transferring hydride ions was synthesized by simply mixing hydrides of transition metals, hydrides of alkali metals, and metal borohydrides in a specific molar ratio, followed by mechanical milling. The synthesized hydride ion conductor exhibits ionic conductivity more than 100 times higher than that of conventional ion conductors containing no borohydrides and no hydrogen (H) vacancies, making it highly suitable for use as a solid electrolyte in various energy storage devices.

### CROSS-REFERENCE TO RELATED PATENT APPLICATION

This application claims the benefit of Korean Patent Application No. 10-2024-0179525, filed on Dec. 5, 2024, in the Korean Intellectual Property Office, the disclosure of which is incorporated herein in its entirety by reference.

### BACKGROUND OF THE INVENTIVE CONCEPT

### 1. Field of the Inventive Concept

The present inventive concept relates to a novel hydride ion conductor, and more particularly, to a hydride ion conductor and a method for manufacturing the same.

### 2. Description of the Related Art

Lithium is currently used as a material for the most advanced energy storage devices and is characterized by its low potential and high energy density.

However, lithium reserves are unevenly distributed, and a series of recent fire incidents caused by lithium-ion batteries has raised safety concerns, thereby creating a need for new materials with improved safety.

Meanwhile, hydride ions (H⁻) have a high polarizability and a low potential (−2.25 V vs. the standard hydrogen electrode), and are therefore expected to be utilized in next-generation energy devices.

However, materials developed as conventional hydride ion conductors generally exhibit low conductivity, and in particular, they are synthesized using highly oxidative elements, such as oxygen (O), fluorine (F), and iodine (I), which cause undesirable side reactions with lithium when applied to lithium batteries.

Accordingly, there is a need for the development of a new hydride ion conductor that exhibits high stability and high hydride ion conductivity, thereby enabling stable operation even at low potential electrodes.

### REFERENCES OF THE RELATED ART

Patent Document: Korean Patent Application Publication No. 10-2016-0137519

### SUMMARY OF THE INVENTIVE CONCEPT

The present inventive concept has been made in an effort to solve the above-described problems associated with prior art, and an object of the present inventive concept is to provide a hydride ion conductor that exhibits high stability and high hydride ion conductivity.

Another object of the present inventive concept is to provide a method for manufacturing the hydride ion conductor.

In order to achieve the above-mentioned objects, one aspect of the present inventive concept provides a hydride ion conductor. The hydride ion conductor is represented by Formula 1 below, has a cubic crystal structure, and having the P4̅3m space group (No. 215):

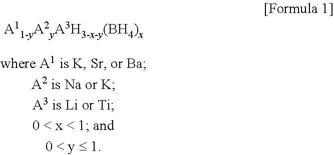

The hydride ion conductor of Formula 1 may have a perovskite structure in which an A³ element is located at the center of a cubic lattice, A¹/A² elements are positioned at the corners of the cubic lattice, and H⁻ and BH₄⁻ coexist at the face centers of the cubic lattice, with the H⁻ and BH₄⁻ forming the vertices of an octahedron.

The hydride ion conductor of Formula 1 may have a BH₄⁻ content (x) of less than 0.4 in molar ratio.

The hydride ion conductor of Formula 1 may have vacancies in the crystal structure, which are formed by partial or complete substitution of A¹ with A².

The hydride ion conductor of Formula 1 may be a compound represented by Formula 2 below:

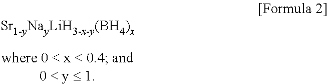

The compound of Formula 2 may exhibit a diffraction peak corresponding to the (100) plane at a 2θ range of 20° to 25° and a diffraction peak corresponding to the (110) plane at a 2θ range of 30° to 35° in X-ray diffraction analysis.

Another aspect of the present inventive concept provides a method for manufacturing the hydride ion conductor. The method for manufacturing the hydride ion conductor may comprise the step of synthesizing a compound powder of Formula 1 by mechanical milling a mixture of a hydride of A¹, A³-BH₄, a hydride of A³, and a hydride of A² in a molar ratio of 1−y:x:1−x:y (0<x<1, and 0<y≤1).

The method for manufacturing the hydride ion conductor may further comprise the step of forming pellets by molding and pressing the synthesized compound powder of Formula 1.

The mechanical milling may be performed at 400 rpm to 800 rpm for 3 to 12 hours.

The pressing may be performed under a pressure of 100 MPa to 500 MPa.

According to the present inventive concept, without relying on conventional highly oxidative elements, such as oxygen (O), fluorine (F), or iodine (I), a hydride ion conductor having a stable crystal structure and capable of transferring hydride ions was synthesized by simply mixing hydrides of transition metals, hydrides of alkali metals, and metal borohydrides in a specific molar ratio, followed by mechanical milling. The synthesized hydride ion conductor exhibits ionic conductivity more than 100 times higher than that of conventional ion conductors containing no borohydrides and no hydrogen (H) vacancies, making it highly suitable for use as a solid electrolyte in various energy storage devices.

### BRIEF DESCRIPTION OF THE DRAWINGS

The above and other features and advantages of the present inventive concept will become more apparent by describing in detail exemplary embodiments thereof with reference to the attached drawings in which:

FIG. 1 shows the X-ray diffraction patterns of a hydride ion conductor according to an embodiment of the present inventive concept;

FIG. 2 is a graph showing neutron diffraction data of a hydride ion conductor according to an embodiment of the present inventive concept;

FIG. 3 is a schematic diagram illustrating the distribution of nuclear density within the hydride ion conductor, based on the neutron diffraction data and the maximum entropy method, according to an embodiment of the present inventive concept;

FIG. 4 shows the changes in the X-ray diffraction patterns with increasing BH₄⁻ content in the crystal structure of hydride ion conductors prepared according to one Experimental Example of the present inventive concept;

FIG. 5 is a graph showing the changes in the lattice constant with increasing BH₄⁻ content in the crystal structure of hydride ion conductors prepared according to one Experimental Example of the present inventive concept; and

FIG. 6 shows the ionic conductivity of hydride ion conductors as a function of temperature according to embodiments of the present inventive concept.

### DETAILED DESCRIPTION OF THE INVENTIVE CONCEPT

Hereinafter, preferred embodiments of the present inventive concept will be described in more detail with reference to the accompanying drawings in order to provide a more specific description of the inventive concept. However, the present inventive concept is not limited to the embodiments described herein and may be embodied in other forms.

Throughout this specification, when a part is referred to as “including” a certain component, it is to be understood that, unless explicitly stated otherwise, the part may further include other components and does not exclude the presence of other components.

As used herein, the terms ‘about’ and ‘substantially’ denote a degree of approximation relative to the stated value, encompassing any material tolerances applicable within the relevant context. These terms serve to facilitate the understanding of the present disclosure and to prevent unfair exploitation through rigid interpretation of precise or absolute values.

Furthermore, when referring to an element-such as a layer, region, or substrate-being ‘on’ another element, it should be understood that the element may be directly positioned on the other element or may include one or more intervening structures therebetween.

Additionally, the use of terms such as ‘first’ and ‘second’ to describe various elements, components, regions, layers, or sections is not intended to impose limitations on such elements. These terms are solely employed for distinguishing purposes and should not be construed as implying any specific ordering or hierarchy.

One aspect of the present inventive concept provides a hydride ion conductor.

The hydride ion conductor according to the present inventive concept is represented by Formula 1 below, has a cubic crystal structure, and has to the P4̅3m space group (No. 215):

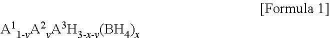

In Formula 1, A¹ may be an alkali metal or alkaline earth metal, such as K, Sr, or Ba.
A² may be an alkali metal, such as Na or K.
A³ may be a metal cation having a radius of less than 1 Å, such as Li or Ti.
x may be greater than 0 and less than 1, and preferably less than 0.4.
y may be greater than 0 and less than or equal to 1. Specifically, y may be one of 0.1, 0.2, 0.3, 0.4, 0.5, 0.6, 0.7, 0.8, 0.9, and 1.0.

The hydride ion conductor of Formula 1 may be a compound represented by Formula 2 below:

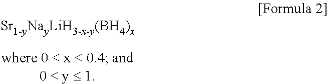

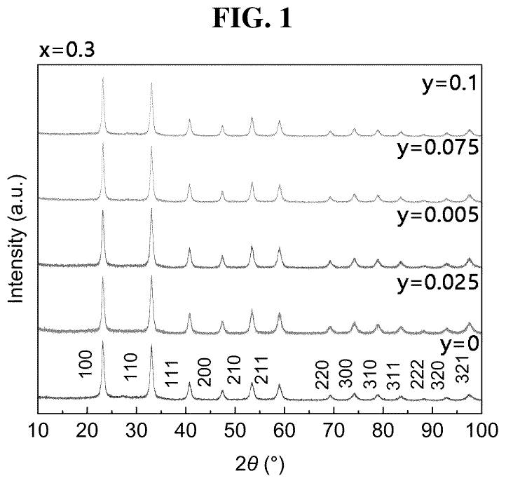

FIG. 1 shows the X-ray diffraction patterns of the hydride ion conductor represented by Formula 1 or Formula 2 according to an embodiment of the present inventive concept;

Referring to FIG. 1, the hydride ion conductor represented by Formula 1 or Formula 2 may have a cubic crystal structure and may have the P4̅3m space group (No. 215), as it exhibits a main diffraction peak corresponding to the (100) plane at a 26 range of 20° to 25°, a main diffraction peak corresponding to the (110) plane at a 26 range of 30° to 35°, intermediate-intensity diffraction peaks corresponding to the (111), (200), (210), and (211) planes at a 2θ range of 40° to 60°, and weak-intensity diffraction peaks corresponding to the (220), (300), (310), (311), (322), (322), (320), and (321) planes at a 2θ range of 65° to 100°.

The hydride ion conductor according to the present inventive concept maintains the same phase without a change in crystal structure even when the content of y increases and A¹ is substituted with A², for example, when SrH₂ is substituted with NaH, resulting in the formation of vacancies at hydrogen sites. These vacancies cannot accommodate large ions such as Li⁺, but can serve as pathways for the migration of hydride ions (H⁻), thereby facilitating ionic conduction.

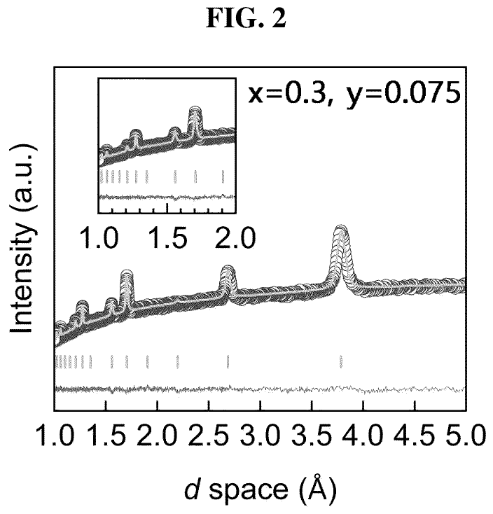

FIG. 2 is a graph showing neutron diffraction data of a hydride ion conductor according to an embodiment of the present inventive concept.

The space group of the hydride ion conductor can be evaluated based on the peak positions in FIG. 2, and the analysis results confirm that it has to the P4̅3m space group of (No. 215).

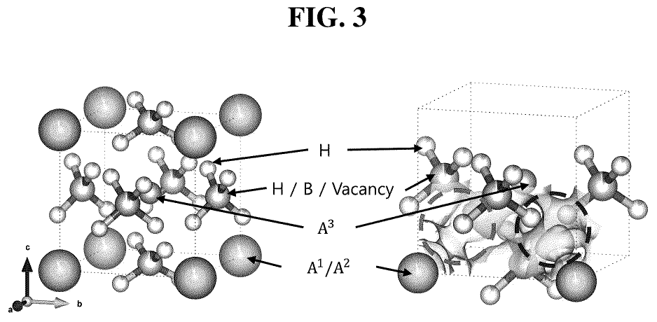

FIG. 3 is a schematic diagram illustrating the distribution of nuclear density within the hydride ion conductor, based on the neutron diffraction data and the maximum entropy method.

Referring to FIG. 3, the hydride ion conductor of the Formula 1 may have a perovskite structure in which an A³ element is located at the center of a cubic lattice, A¹/A² elements are positioned at the corners of the cubic lattice, and H⁻ and BH₄⁻ coexist at the face centers of the cubic lattice, with the H⁻ and BH₄⁻ forming the vertices of an octahedron.

The hydride ion conductor of Formula 1 may have vacancies at hydrogen sites in the crystal structure, which are formed by partial or complete substitution of A¹ with A².

Moreover, with respect to the interaction between BH₄⁻ ions and cations in the crystal lattice, BH₄⁻ ions exhibit strong interaction with A¹/A² cations in the black dashed-line region in FIG. 3, whereas relatively weak interaction is observed in the gray dashed-line region on the opposite side, thereby allowing hydride ions (H⁻) to be conducted through the gray dashed-line region.

The hydride ion conductor of Formula 1 according to the present inventive concept may have a BH₄⁻ content (x) of less than 0.4 in molar ratio.

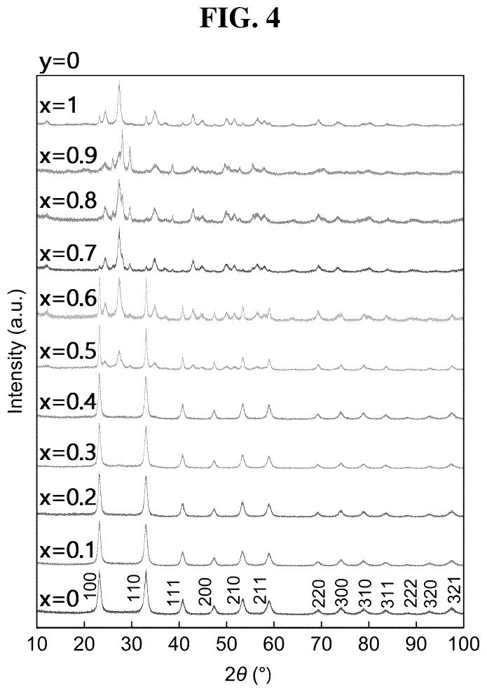

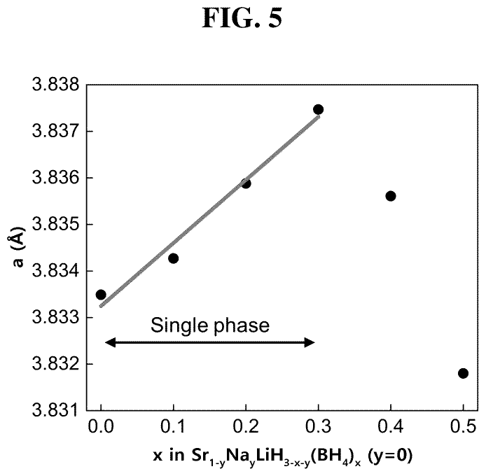

FIGS. 4 and 5 respectively show the changes in the X-ray diffraction patterns and lattice constants with increasing BH₄⁻ content in the crystal structure of the hydride ion conductors prepared according to one Experimental Example of the present inventive concept.

As shown in FIGS. 4 and 5, when the content of BH₄⁻, i.e., the x value, is less than 0.4, the hydride ion conductor maintains a single-phase cubic perovskite structure. However, when the x value increases to 0.4 or higher, additional secondary peaks are observed, indicating a phase transition from the cubic perovskite structure to a different structure.

Furthermore, according to Vegard's law, which states that the lattice constant increases linearly with the successful substitution of specific ions, the lattice constant was observed to increase linearly with increasing x up to 0.3, as shown in FIG. 5. However, when x reached 0.4, the lattice constant decreased, indicating that a single-phase is maintained only when x is less than 0.4.

Therefore, during the synthesis of the hydride ion conductor, a stable crystal structure can be maintained at a BH₄⁻ content of less than 0.4 in molar ratio.

Still another aspect of the present inventive concept provides a method for manufacturing the hydride ion conductor.

The method for manufacturing the hydride ion conductor may comprise the step of synthesizing a compound powder of Formula 1 by mechanical milling a mixture of a hydride of A¹, A³-BH₄, a hydride of A³, and a hydride of A² in a molar ratio of 1−y:x:1−x:y (0<x<1, and 0<y≤1).

The mechanical milling may be performed by a method commonly used in the art, such as ball milling or planetary milling, but is not limited thereto. For example, the mechanical milling may be performed using high-energy ball milling. High-energy milling refers to a method in which the sample is repeatedly impacted and mixed by balls rotating at high speed with high energy in the reactor, resulting in synthesis through pulverization of the sample to the nanometer scale. In this case, the mechanical milling may be performed at 400 rpm to 800 rpm for 3 to 12 hours, but is not limited thereto, and may be continued until the synthesis into the compound powder of Formula 1 is sufficiently completed.

The method for manufacturing the hydride ion conductor may further comprise the step of forming pellets by molding and pressing the synthesized compound powder of Formula 1.

The molding and pressing may be performed by a method commonly used in the art, and for example, the pressing may be performed under a pressure of 100 MPa to 500 MPa.

According to the present inventive concept, without relying on conventional highly oxidative elements such as oxygen (O), fluorine (F), or iodine (I), a hydride ion conductor having a stable crystal structure and capable of transferring hydride ions was synthesized by simply mixing hydrides of transition metals, hydrides of alkali metals, and metal borohydrides in a specific molar ratio, followed by mechanical milling. When the BH₄⁻ content (x value) was 0.3 in molar ratio and the A² substitution level (y value) was 0.075 in molar ratio, the synthesized hydride ion conductor exhibited an ionic conductivity of 1.01×10⁻⁴ S cm⁻¹ at 100° C., which is more than 100 times higher than that of a conventional ion conductor (5.88×10⁻⁷ S cm⁻¹) containing no borohydrides and no hydrogen (H) vacancies. As such, the hydride ion conductor according to the present inventive concept has a stable crystal structure and exhibits significantly higher ionic conductivity than conventional hydride ion conductors, and thus can be effectively used as a solid electrolyte in various energy storage devices.

Next, preferred Preparation Examples and Experimental Examples are provided to facilitate understanding of the present inventive concept. However, these examples are presented for illustrative purposes only and are not intended to limit the scope of the present inventive concept.

### Preparation Example 1: Preparation of Sr_{1-y}Na_{y}LiH_{3-x-y}(BH₄)ₓ (x=0.3, y=0.025)

SrH₂, LiBH₄, LiH, and NaH were mixed in a molar ratio of 1−y:x:1−x:y (x=0.3, y=0.025), and the total weight of the mixture was adjusted to 0.5 g to 4 g. The mixture was then loaded into a ball milling apparatus and subjected to ball milling at 400 rpm to 800 rpm for 3 to 12 hours to form a powder of Sr_{1-y}Na_{y}LiH_{3-x-y}(BH₄)ₓ (x=0.3, y=0.025).

### Preparation Examples 2 to 4 and Comparative Examples 1 to 11: Preparation of Sr_{1-y}Na_{y}LiH_{3-x-y}(BH₄)ₓ

Powders of Sr_{1-y}Na_{y}LiH_{3-x-y}(BH₄)ₓ were prepared in the same manner as in Preparation Example 1, except that the values of x and y were varied as shown in Table 1 below:

TABLE 1

Sr_{1-y}Na_{y}LiH_{3-x-y}(BH₄)ₓ

| Examples | x | y |
|---|---|---|
| Comparative Example 1 | 0 | 0 |
| Comparative Example 2 | 0.1 | 0 |
| Comparative Example 3 | 0.2 | 0 |
| Comparative Example 4 | 0.3 | 0 |
| Comparative Example 5 | 0.4 | 0 |
| Comparative Example 6 | 0.5 | 0 |
| Comparative Example 7 | 0.6 | 0 |
| Comparative Example 8 | 0.7 | 0 |
| Comparative Example 9 | 0.8 | 0 |
| Comparative Example 10 | 0.9 | 0 |
| Comparative Example 11 | 1.0 | 0 |
| Preparation Example 1 | 0.3 | 0.025 |
| Preparation Example 2 | 0.3 | 0.05 |
| Preparation Example 3 | 0.3 | 0.075 |
| Preparation Example 4 | 0.3 | 0.1 |

### Preparation Examples 5 to 8: Preparation of Ba_{1-y}K_{y}LiH_{3-x-y}(BH₄)ₓ

Powders of Ba_{1-y}K_{y}LiH_{3-x-y}(BH₄)ₓ were prepared in the same manner as in Preparation Examples 1 to 4, except that BaH₂ was used instead of SrH₂, and KH was used instead of NaH.

### Preparation Examples 9 to 12: Preparation of K_{1-y}Na_{y}TiH_{3-x-y}(BH₄)ₓ

Powders of K_{1-y}Na_{y}TiH_{3-x-y}(BH₄)ₓ were prepared in the same manner as in Preparation Examples 1 to 4, except that KH was used instead of SrH₂, and TiH₂ was used instead of LiH.

### Analysis

FIG. 1 shows the X-ray diffraction patterns of the hydride ion conductors prepared in Preparation Examples 1 to 4 of the present inventive concept and Comparative Example 4.

As shown in FIG. 1, the hydride ion conductor prepared according to the present inventive concept exhibits a main diffraction peak corresponding to the (100) plane at a 2θ range of 20° to 25°, a main diffraction peak corresponding to the (110) plane at a 26 range of 30° to 35°, intermediate-intensity diffraction peaks corresponding to the (111), (200), (210), and (211) planes at a 2θ range of 40° to 60°, and weak-intensity diffraction peaks corresponding to the (220), (300), (310), (311), (322), (322), (320), and (321) planes at a 2θ range of 65° to 100°. As a result of the analysis of the diffraction pattern, the hydride ion conductor was found to have a cubic crystal structure and to have the P4̅3m space group (No. 215).

The hydride ion conductor prepared according to the present inventive concept was found maintain the same phase without a change in crystal structure even when the content of y increases and A¹ is substituted with A², for example, when SrH₂ is substituted with NaH, resulting in the formation of vacancies at hydrogen sites. These vacancies can serve as pathways for the migration of hydride ions (H⁻), thereby facilitating ionic conduction.

FIG. 2 is a graph showing neutron diffraction data of the hydride ion conductor prepared in Preparation Example 3 of the present inventive concept, and FIG. 3 is a schematic diagram illustrating the distribution of nuclear density within the hydride ion conductor, based on the neutron diffraction data and the maximum entropy method.

Referring to FIGS. 2 and 3, the hydride ion conductor has a perovskite structure in which Sr²⁺ or Na⁺ is located at the corner of a cubic structure, Li is positioned at the center of the cubic structure, and H⁻ and BH₄⁻ are located at the face centers of the cubic structure and form the vertices of an octahedron. Accordingly, it can be understood that the crystal structure of the hydride ion conductor is specifically a cubic perovskite structure.

Moreover, as shown in FIG. 3, in the interaction between BH₄⁻ ions and cations within the crystal lattice, BH₄⁻ ions exhibit strong interaction with A¹/A² cations in the black dashed-line region, whereas relatively weak interaction is observed in the gray dashed-line region on the opposite side, thereby allowing hydride ions (H⁻) to be conducted through the gray dashed-line region, thereby enabling high ionic conductivity.

### Experimental Example 1: Effect of BH₄⁻ Content on Single-Phase Formation

The following experiment was conducted to investigate the effect of BH₄⁻ content (x) on the crystal structure of the hydride ion conductor during its synthesis according to the present inventive concept.

Specifically, X-ray diffraction analysis was performed on the compounds prepared in Comparative Examples 1 to 10, where y=0 and x varies, and the results are shown in FIG. 4. The lattice constant (a) was measured for each sample, and the results are shown in FIG. 5.

FIG. 4 shows the changes in the X-ray diffraction patterns with increasing BH₄⁻ content in the crystal structure of the hydride ion conductors prepared according to one Experimental Example of the present inventive concept.

FIG. 5 is a graph showing the changes in the lattice constant with increasing BH₄⁻ content in the crystal structure of the hydride ion conductors prepared according to one Experimental Example of the present inventive concept.

As shown in FIG. 4, it was confirmed that when the x value, i.e., the BH₄⁻ content was 0.4 or less, the same cubic perovskite structure as observed in the XRD pattern of FIG. 1 appeared. However, when the x value increased to 0.4 or higher, additional secondary peaks were observed, indicating a phase transition from the cubic perovskite structure to a different structure.

Meanwhile, according to Vegard's law, which states that the lattice constant increases linearly with the successful substitution of specific ions, the lattice constant was observed to increase linearly with increasing x up to 0.3, as shown in FIG. 5. However, when x reached 0.4, the lattice constant decreased, indicating that a single-phase is maintained only when x is less than 0.4.

Therefore, it was confirmed that during the synthesis of the hydride ion conductor, a stable crystal structure is maintained at a BH₄⁻ content of less than 0.4 in molar ratio.

### Experimental Example 2: Measurement of Hydride Ion Conductivity

The following experiment was conducted to measure the ionic conductivity of the hydride ion conductors according to the present inventive concept as a function of temperature.

Specifically, the compound powders prepared in Comparative Examples 1 and 4 and Preparation Examples 1 to 4 were pressed into pellets under a pressure of 100 MPa to 500 MPa to form hydride ion conductor pellets having a diameter of 10 mm and a thickness of 0.5 mm to 0.8 mm.

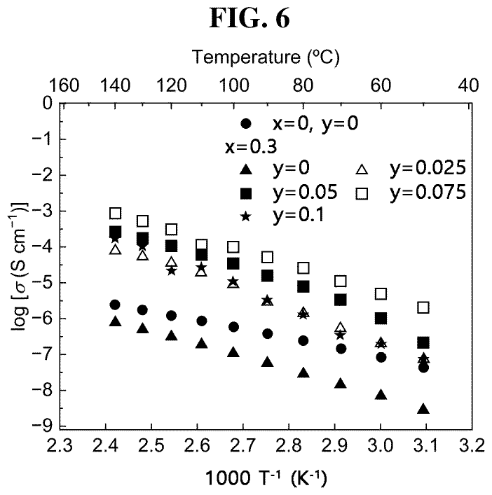

The ionic conductivity of the hydride ion conductor pellets was measured as a function of temperature, and the results are shown in FIG. 6 and Table 2 below.

FIG. 6 shows the ionic conductivity of hydride ion conductors as a function of temperature according to embodiments of the present inventive concept.

TABLE 2

| | Ionic Conductivity |
|---|---|
| Examples (Sr_{1-y}Na_{y}LiH_{3-x-y}(BH₄)ₓ) | at 100° C. (S cm⁻¹) |
| Comparative Example 1 (x = 0, y = 0) | 5.88 × 10⁻⁷ |
| Comparative Example 4 (x = 0.3, y = 0) | 1.06 × 10⁻⁷ |
| Preparation Example 1 (x = 0.3, y = 0.025) | 9.54 × 10⁻⁶ |
| Preparation Example 2 (x = 0.3, y = 0.05) | 3.42 × 10⁻⁵ |
| Preparation Example 3 (x = 0.3. y = 0.075) | 1.01 × 10⁻⁴ |
| Preparation Example 4 (x = 0.3, y = 0.1) | 1.06 × 10⁻⁵ |

As shown in FIG. 6 and Table 2, by incorporating a specific content of BH₄⁻ and introducing appropriate vacancies, the hydride ion conductors according to the present inventive concept exhibited ionic conductivities 100 to 1,000 times higher than those of the samples containing no BH₄⁻ (x=0) and no vacancies (y=0).

This suggests that, in the hydride ion conductor, a portion of the BH₄⁻ ions exhibit strong interaction with cations as complex anions, resulting in regions with relatively weak interactions. These regions serve as pathways for the migration of hydride ions (H⁻), thereby enhancing ionic conductivity. Furthermore, the substitution of divalent metal hydrides with monovalent metal hydrides in the hydride ion conductor creates vacancies that cannot accommodate Li⁺ ions, but can facilitate the transfer of H⁻ ions, thereby further enhancing ionic conductivity.

Therefore, in the hydride ion conductor according to the present inventive concept, the coexistence of complex anion, such as complex anions BH₄⁻ and hydride ions H⁻, enables the complex anions to regulate the ion conduction pathway, and owing to their high reducing ability, the presence of these anions improves the hydride ion conductivity by more than 100 times compared to cases where no complex anion is present. Accordingly, the hydride ion conductor of the present inventive concept can be effectively used as a solid electrolyte in next-generation energy storage devices, including fuel cells.

It is to be understood that the embodiments of the present inventive concept disclosed in the specification and drawings are provided as specific examples to facilitate understanding, and are not intended to limit the scope of the inventive concept. It will be apparent to those skilled in the art to which the inventive concept pertains that various modifications and changes may be made to these embodiments without departing from the spirit and scope of the inventive concept.

What is claimed is:

1. A hydride ion conductor represented by Formula 1 below, having a cubic crystal structure, and having the P4̅3m space group (No. 215)

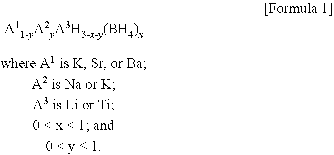

2. The hydride ion conductor according to claim 1, wherein the hydride ion conductor of Formula 1 has a perovskite structure in which an A³ element is located at the center of a cubic lattice, A¹/A² elements are positioned at the corners of the cubic lattice, and H⁻ and BH₄⁻ coexist at the face centers of the cubic lattice, with the H⁻ and BH₄⁻ forming the vertices of an octahedron.

3. The hydride ion conductor according to claim 1, wherein the hydride ion conductor of Formula 1 has a BH₄⁻ content (x) of less than 0.4 in molar ratio.

4. The hydride ion conductor according to claim 1, wherein the hydride ion conductor of Formula 1 has vacancies in the crystal structure, which are formed by partial or complete substitution of A¹ with A².

5. The hydride ion conductor according to claim 1, wherein the hydride ion conductor of Formula 1 is a compound represented by Formula 2 below:

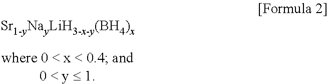

6. The hydride ion conductor according to claim 5, wherein the compound of Formula 2 exhibits a diffraction peak corresponding to the (100) plane at a 2θ range of 20° to 25° and a diffraction peak corresponding to the (110) plane at a 2θ range of 30° to 35° in X-ray diffraction analysis.

7. A method for manufacturing a hydride ion conductor, the method comprising the step of synthesizing a compound powder of Formula 1 by mechanical milling a mixture of a hydride of A¹, A³-BH₄, a hydride of A³, and a hydride of A² in a molar ratio of 1−y:x:1−x:y (0<x<1, and 0<y≤1):

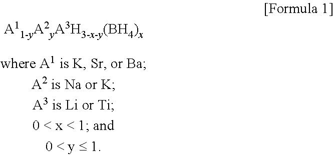

8. The method for manufacturing a hydride ion conductor according to claim 7, further comprising the step of forming pellets by molding and pressing the compound powder of Formula 1.

9. The method for manufacturing a hydride ion conductor according to claim 7, wherein the mechanical milling is performed at 400 rpm to 800 rpm for 3 to 12 hours.

10. The method for manufacturing a hydride ion conductor according to claim 8, wherein the pressing is performed under a pressure of 100 MPa to 500 MPa.
